(19) United States
(12) Patent Application Publication
(10) Pub. No.: US 2003/0170906 A1
(43) Pub. Date: Sep. 11, 2003

(54) Conductive diamond spectrographic cells and method of use

(75) Inventors: Greg M. Swain, East Lansing, MI (US); Jerzy K. Zak, Katowice (PL); James E. Butler, Huntingtown, MD (US)

Correspondence Address: MCLEOD & MOYNE, P.C., 2190 COMMONS PARKWAY, OKEMOS, MI, 48864, US

(73) Assignee: Board of Trustees of MICHIGAN STATE UNIVERSITY, East Lansing, MI

(21) Appl. No.: 10/338,334

(22) Filed: Jan. 8, 2003

Related U.S. Application Data
(60) Provisional application No. 60/350,990, filed on Jan. 23, 2002.

(51) Int. Cl. G01N 21/62

(52) U.S. Cl. 436/171

(57) ABSTRACT

A spectroelectrochemical cell (10 or 30) with a transparent conductive diamond electrode (15 or 35), which is free standing or deposited on quartz is described. The conductive electrode allows oxidation or reduction reactions to be initiated in the cell electrochemically by the electrode so as to observe the reaction over time spectroscopically.

### CROSS REFERENCE TO RELATED APPLICATIONS

The present application claims priority to U.S. Provisional Application Serial No. 60/350,990, filed Jan. 23, 2002.

### GOVERNMENT RIGHTS

The research disclosed in this application was supported by the National Science Foundation Grant No. CHE-9505683. The U.S. government has certain rights to this invention.

### BACKGROUND OF THE INVENTION

(1) Field of the Invention

The present invention relates to a spectroelectrochemical cell and method of use thereof which uses an electrode which is conductive polished polycrystalline diamond doped with an electrically conductive element, such as boron. In particular, the electrode allows the spectrographic observation of electrically induced oxidation-reduction reactions.

(2) Description of Related Art

Spectroelectrochemical methods of analysis have been used for over three decades to investigate various heterogeneous electron-transfer processes (Kuwana, T. Ber. Bunsen-Ges. Phys. Chem. 77 858 (1973); and Kuwana, T., et al., In Electroanalytical Chemistry, Bard, A. J., Ed.; Marcel Dekker. New York Vol. 7, pp 1 (1974)). Such measurements are generally accomplished using optically transparent electrodes (OTEs), such as indium-doped tin oxide (ITO) films deposited on glass or quartz substrates, thin metal films of Au and Pt deposited on glass or quartz, or thin metal meshes and grids. Spectroelectrochemistry is useful for investigating electrode reaction mechanisms (Osa, T., et al., J. Electroanal. Chem. Interfacial Electrochem. 22 389 (1969); Landrum, H. L., et al., J. Am. Chem. Soc. 99 3154 (1977); Armstrong, N. R., et al., Anal. Chem. 48 750 (1976); Cieslinski, R., et al., Anal. Chem. 51 565 (1979); Cieslinski, R. C., et al., J. Electrochem. Soc. 127 2605 (1980); Bowden, E. F., et al., J. Electroanal. Chem. 125 367 (1981); Stargardt, J. F., et al., Anal. Chim. Acta 146 1 (1983); Zak, J., et al., Anal. Chem. 55 2219 (1983); White, J. R., et al., J. Electroanal. Chem. 197 233 (1986); Pharr. C. M., et al., Anal. Chem. 69 4665 (1997); and Pharr. C. M., et al., Anal. Chem. 69 4673 (1997)) and for electroanalytical applications (Shi, T., et al., Anal. Chem. 69 3679 (1997); Shi, Y., et al., Anal. Chem. 69 4819 (1997); Slaterbeck, A. F., et al., anal. Chem. 71 1196 (1999); and Letian, G., et al., Anal. Chem. 71 4061 (1999)). The optical signals generated electrochemically can be monitored in either a transmission or an attenuated total reflectance mode (Kuwana, T., Ber. Bunsen-Ges. Phys. Chem. 77 858 (1973)). The probe beam of light in the transmission mode is directed normal to the surface and passes through the electrode and electrochemical cell. The probe beam of light in the attenuated total reflectance mode is coupled, at an appropriate angle, to and propagates within the OTE by internal reflection (Shi, T., et al., Anal. Chem. 69 3679 (1997)). Attenuation of the light occurs within a wavelength or so adjacent to the OTE surface through interaction of the evanescent field of the totally reflected light with the light-absorbing solution species adjacent to the electrode surface. The use of conductive polycrystalline diamond electrodes for oxidation and reduction reactions is well known in the prior art. Illustrative is the article by Granger et al, Anal. Chem. 72 3793-3804 (2000) and U.S. Pat. No. 6,106,692 to Kunimatsu et al and U.S. Pat. No. 5,900,127 to Iida et al.

The use of electrically conductive diamond films as electrode materials is a relatively new field of research (Xu, J., et al., Anal. Chem. 69 591A (1997); Swain, G. M., et al., MRS Bull. 23 56 (1998); Tenne, R., et al., Isr. J. Chem. 38 57 (1998); Pleskov, Y. V., Russ. Chem. Rev. 68 381 (1999)). For electroanalysis, diamond possesses some superb properties that make it quite useful for the detection of several analytes including azide (Xu, J., et al., Anal. Chem. 70 1502 (1998); and Xu, J., et al., Anal. Chem. 71 4603 (1999)) hydrazine (Fabrezius, H., et al.,—unpublished results), nitrite (Granger, M. C., et al., Anal. Chim. Acta 397 145 (1999)), NADH (Rao, T. N., et al., Anal. Chem. 71 2506 (1999)), and aliphatic polyamines (Jolley, S., et al., Anal. Chem. 69 4099 (1997); Koppang, M., et al., Anal. Chem. 71 1188 (1999); and Witek, M., et al.,—submitted). Several important material properties are (i) a resistance to fouling on the nonpolar, hydrogen-terminated surface due to weak adsorption of polar molecules, (ii) a low and stable background current over a wide potential range, (iii) a pH-independent background current and capacitance on the hydrogen-terminated surface, (iv) a wide working potential electrode in aqueous media, (v) excellent morphological and microstructural stability at extreme anodic and cathodic potentials and current densities, and (vi) good electrochemical kinetics for several redox systems without any kind of conventional pretreatment. For example k^{o}ₐₚₚ for Fe(CN)₆^{3-/4-} is ˜0.02 cm/s and for methyl viologen is ˜0.2 cm/s at clean, hydrogen-terminated diamond (Granger, M. C., et al., Anal. Chem. 72 3793 (2000)).

One property of diamond that has not yet been exploited in electrochemistry or chemical analysis is the optical transparency. High-quality (chemically pure and low in defects) diamond has one of the widest optical electrodes of any material extending from the band gap absorption edge at 225 nm well out to 12 μm or more in the far-IR (Tzeng, Y. Diamond Films Technol. 1 31 (1991)). Such diamond is free of allowed electronic states in the band gap between the valence and conduction band edges, and is, in theory, transparent to low-energy UV and the entire range of visible light. However, imperfections in diamond, like those that exist in boron-doped polycrystalline films, create electronic and vibrational states within the gap that give rise to multiple absorption and luminescence centers spanning from the UV to the near-IR and reduce the visible light throughput (Tzeng, Y., Diamond Films Technol. 1 31 (1991); and Zhu, W. In Diamond: Electronic Properties and Applications, Pan, L. S., et al. Eds.; Kluwer Academic publishers: Boston; 1995; Chapter 5, p 175. Pankove, J. L.; Qui, C.-H. In Synthetic Diamond: Emerging CVD Science and Technology, Spear, K. E., Dismukes, J. P., Eds.; John Wiley & Sons: New York Chapter 11, p 401 (1994)). Defects in diamond can be structural and/or chemical in nature. Structural defects include grain boundaries, stacking faults, dislocations, and twin boundaries, as well as point defects such as vacancies and divacancies, although the latter two have not been observed yet in chemically vapor deposited (CVD) diamond. Nitrogen and boron are common chemical impurities in diamond that occur as interstitial or substitutional point defects and defect complexes (Tzeng, Y., Diamond Films Technol. 1 31 (1991); and Zhu, W. In Diamond: Electronic Properties and Applications, Pan, L. S., et al. Eds.; Kluwer Academic publishers: Boston; 1995; Chapter 5, p 175. Pankove, J. L.; Qui, C.-H. In synthetic Diamond: Emerging CVD Science and Technology, Spear, K. E., Dismukes, J. P., Eds.; John Wiley & Sons: New York Chapter 11, p 401 (1994); Mainwood, A., Phys Rev. B. 49 7934 (1994); Freitas, J. A., Jr.; Klein, P. B.; Collins, A. T. Appl. Phys. Lett. 64 2136 (1994); Cox, A.; Newton, M. E.; Baker, J. M., J. Phys. Codens. Matter. 6 551 (1994)). Nitrogen, for example, is well known to cause electronic absorption in the UV and blue regions of the visible spectrum, resulting in a yellow coloration (Zhu, W. In Diamond: Electronic Properties and Applications, Pan, L. S., et al. Eds.; Kluwer Academic publishers: Boston; 1995; Chapter 5, p 175. Pankove, J. L.; Qui, C.-H. In synthetic Diamond: Emerging CVD Science and Technology, Spear, K. E., Dismukes, J. P., Eds.; John Wiley & Sons: New York Chapter 11, p 401 (1994); Mainwood, A., Phys Rev. B. 49 7934 (1994); Freitas, J. A., Jr.; Klein, P. B.; Collins, A. T. Appl. Phys. Lett. 64 2136 (1994); Cox, A.; Newton, M. E.; Baker, J. M., J. Phys. Codens. Matter. 6 551 (1994)).

High-quality, chemically pure diamond shows optical transparency in the IR, as well. However, weak IR absorption in the 3-5-μm range occurs when lattice phonons (i.e., lattice vibrations) are created as a result of absorbed photons (Tzeng, Y. Diamond Films Technol. 1 31 (1991)). High-quality diamond is a very useful electrode material for transmission in the far-IR (˜5-16 μm or ˜2000-600 cm⁻¹). However, defects and impurities incorporated into polycrystalline, CVD films lead to a loss of crystal symmetry and reduced optical transparency in this region (Zhu, W. In Diamond: Electronic Properties and Applications, Pan, L. S., et al. Eds.; Kluwer Academic publishers: Boston; 1995; Chapter 5, p 175. Pankove, J. L.; Qui, C.-H. In synthetic Diamond: Emerging CVD Science and Technology, Spear, K. E., Dismukes, J. P., Eds.; John Wiley & Sons: New york Chapter 11, p 401 (1994)). For example, substitutional nitrogen leads to a peak at 1130 cm⁻¹, nearest-neighbor pairs of nitrogen give rise to a peak at 1280 cm⁻¹, and nitrogen platelets lead to a characteristic 1370 cm⁻¹ absorption peak in natural diamond. No evidence of platelets and nitrogen clusters has been found yet in CVD diamond. The spectral region between 2700 and 3000 cm⁻¹ is also somewhat opaque due to absorption by C—H symmetric and antisymmetric vibrational modes associated with surface and defect terminal functionalities. Finally, boron doping reduces the transparency in the mid-IR. Boron introduces 2790- and 2460-cm⁻¹ absorption bands due to electronic transitions from the ground state to excited states of the dopant atoms (Zhang, F., et al., Mater. Lett. 19 115 (1994); and McNamara, K. M., et al., J. Appl. Phys. 76 2466 (1994)). As the boron concentration is increased to 0.1% or greater, these two bands broaden due to wave function overlapping of nearby acceptor centers forming a dopant band and associated lattice strains (Gonon, P., et al., J. Appl. Phys. 78 7059 (1995)). This can extend from 1800 cm⁻¹ to the visible region of the spectrum. The diamond OTE used presently was opaque from about 4500 to 2000 cm⁻¹ due to the high doping level, but relatively transparent from 1500 to 500 cm⁻¹.

It should be pointed out that a possible limitation of diamond for transmission measurements is its large reflectivity due to the high refractive index (2.41 at 591 nm) (Yoder, M. In Synthetic Diamond: Emerging CVD Science and Technology, Spear, K. E., Dismukes, J. P., Eds.; John Wiley & Sons: New York Chapter 1, p. 4 (1994)). The optical reflection and transmission are strongly influenced by the surface roughness of the CVD diamond film, the boron-doping level, the nondiamond content and other impurity levels, the defect density, and the film thickness.

The use of electrically conducting diamond as an optically transparent electrode (OTE) for spectroelectrochemical measurements has only recently begun to be studied (Martin, H. B., et al., Electrochem. Solid-State Lett. 4 (2001)). Diamond has a wide optical electrode, although not continuous, ranging from the near-UV to the far-IR. Depending on the defect density, chemical composition, doping level, thickness and grain size, boron-doped diamond films are transparent in the visible (300-900 nm) and far-infrared (<1100 cm⁻¹) regions of the electromagnetic spectrum (Ogasawara, A., et al., Diamond Relat. Mater. 6 835-838 (1997)). Moreover, the optical properties of diamond films can be manipulated and optimized through adjustments in the deposition conditions. The wide optical electrode, coupled with the interesting electrochemical properties, make diamond a new and unique material as an optically transparent electrode (Martin, H. B., et al., Electrochem. Solid-State Lett. 4 E17-E20 (2001)).

The present invention uses a diamond deposition process similar to that described by Gruen et al. See for example U.S. Pat. Nos. 5,989,511; 5,849,079 and 5,772,760. The patents to Gruen et al. describe processes for synthesizing relatively smooth polycrystalline diamond films starting with the mixing of carbonaceous vapors, such as methane or acetylene gas, with a gas stream consisting of mostly an inert or noble gas, such as argon, with, if necessary, also small fractional (1-3%) additions of hydrogen gas. This gas is then activated in, for example, in a microwave plasma environment, and under the appropriate conditions of pressure, gas flow, microwave power, substrate temperature and reactor configuration, nanocrystalline diamond films are deposited on a substrate.

Other related patents relating to diamond deposition are U.S. Pat. No. 5,209,916 to Gruen; U.S. Pat. No. 5,328,676 to Gruen; U.S. Pat. No. 5,370,855 to Gruen; U.S. Pat. No. 5,462,776 to Gruen; U.S. Pat. No. 5,620,512 to Gruen; U.S. Pat. No. 5,571,577 to Zhang et al; U.S. Pat. No. 5,645,645 to Zhanq et al; U.S. Pat. No. 5,897,924 to Ulczynski et al and U.S. Pat. No. 5,902,640 to Krauss which are all incorporated by reference herein.

There is a technological need for more robust optically transparent electrode that can be used for spectroelectrochemical measurements in harsh chemical environments.

### OBJECTS

It is an object of the present invention to provide a novel electrode and cell using a polished polycrystalline diamond electrode for initiation and observation of oxidation and reduction reactions. It is further an object of the present invention to provide a spectroelectrochemical cell which produces useful observations of oxidation and reduction reactions, particularly under harsh chemical conditions. These and other objects will become increasingly apparent by reference to the following description.

### SUMMARY OF THE INVENTION

The present invention relates to a method for spectroscopically observing oxidation-reduction reactions which comprises:

providing an oxidation and reduction reaction cell with a smooth light transparent electrode of conductive polycrystalline diamond doped with an electrically conductive element;

introducing a reagent for the oxidation or reduction reaction into the cell; and

conducting the oxidation or reduction with the reagent activated by electrical conduction through the electrode, while spectroscopically measuring a change of the reagent or derivative thereof in the cell through the electrode over time.

The present invention further relates to an improved cell for spectroscopically observing an oxidation and reduction reaction wherein the reaction is conducted in a cell with a reagent for the oxidation reduction reaction adjacent a spectroscopic electrode, which comprises a polished, conductive polycrystalline diamond electrode doped with an electrically conductive element, wherein the electrode allows for spectroscopic measurement of a change of the reagent or derivative thereof in the cell through the electrode over time when activated by electrical conduction through the electrode.

Preferably the diamond is doped with boron. Preferably the electrode is less than about 350 micrometers thick. Preferably the electrode has a surface in contact with the reagents which is hydrogen terminated.

### DESCRIPTION OF DRAWINGS

FIG. 1 is a schematic view of a thin-layer spectroelectrochemical cell 10.

FIG. 2 is an atomic force microscope image of a polished diamond optically transparent electrode (OTE). FIG. 2A is a scale for estimating the dimensions.

FIG. 3 is a graph showing absorbence spectra (in air) for a piece of indium-doped tin oxide and the diamond OTE.

FIG. 4 is a graph showing background cyclic voltammetric i-E curve for the diamond OTE in 0.1 M KCl. The measurement was made in a conventional glass electrochemical cell. Scan rate, 100 mV/s.

FIG. 5 is a graph showing a cyclic voltammetric i-E curve for 1 mM Fe(CN)₆⁴⁻ in 1 M KCl at the diamond OTE. The measurement was made in the thin-layer electrochemical cell. Scan rate, 2 mV/s. FIG. 5B is a graph showing absorbance curves for the formation via electrooxidation of optically active Fe(CN)₆³⁻ at different applied potentials beginning at 100 mV and ending at 400 mV. The spectra were obtained every 50 mV in this range.

FIG. 6A is a graph showing a cyclic voltammetric i-E curve for 0.5 mM methyl viologen (MV²⁺) in 1 M NaCl at the diamond OTE. The measurement was made in a conventional glass electrochemical cell. Scan rate, 50 mV/s. FIG. 6B is a graph showing absorbance curves for the formation via electroreduction of optically active cation radical (MV⁺) and FIG. 6C is a graph showing the neutral (MV^{o}). The spectra in FIG. 6B were obtained over a potential range from −600 to −1000 mV and the spectra in FIG. 6C over a potential range from −1000 to −1400 mV.

FIG. 7 is a diagram of a transmission thin-layer spectroelectrochemical cell (30) with a KEL-F insert, (32) quartz cuvette, (33) polished quartz, (34) 150-μm silicone gasket, (35) boron-doped diamond OTE, (36) Ag-QRE, and (37) Pt auxiliary electrode.

FIG. 8A shows an optical micrograph and FIG. 8B shows an AFM image (height mode) of an as-grown, boron-doped diamond thin film deposited on a scratched quartz substrate for 1 h. FIG. 8C shows an AFM image (height mode) of boron-doped diamond deposited for 1 h on a poorly prepared quartz substrate.

FIG. 9 is a graph showing UV-visible transmission spectra for boron-doped diamond thin film deposited on quartz for 1 and 2 h. The films were deposited from a source gas mixture of 0.5% C/H and 10 ppm B₂H₆.

FIG. 10 is a graph of a cyclic voltammetric i-E curve in 1 M KCl for a diamond thin film deposited on quartz for 1 h. Scan rate, 25 mV/s. The film was deposited as described for FIG. 3.

FIGS. 11A and 11B are graphs of UV-visible transmission of spectra for (FIG. 11A) a diamond thin film before and after 15 and 30 cycles in 1 M KCl and (FIG. 11B) the diamond film OTE before potential cycling and after 10 cycles in 1 M HNO₃ and 5 cycles in 1 M NaOH. The measurements were made in the thin-layer spectroelectrochemical cell, using 1 M KCl. The film was deposited as described in FIG. 9.

FIG. 12 is a graph showing a background-corrected, thin-layer voltammetric i-E curve for a diamond thin film, deposited on quartz for 1 h, in 0.1 mM CPZ in 10 mM H₂SO₄. Scan rate, 2 mV/s. The film was deposited as described in FIG. 9.

FIGS. 13A and 13B are—FIG. 13A UV-visible absorbance spectra at a diamond thin film, deposited on quartz for 1 h, for chlorpromazine (CPZ^{o}), at 0.30 V, and the oxidation product (CPZ^{o+}), at 0.50 V, in the thin-layer cell. FIG. 13B shows a series of UV-visible absorbance spectra, using the same film, for 0.1 mM chlorpromazine in 10 mM HClO₄, as the potential is stepped from 0.32 to 0.47 V vs Ag-QRE. The film was deposited as described for FIG. 9.

### DESCRIPTION OF PREFERRED EMBODIMENTS

Through optimization of the deposition conditions and careful minimization of incorporated impurities and defects, the optical properties of diamond in the near-UV, visible, and IR regions of the electromagnetic spectrum are adjustable and optimizable in a controlled fashion.

Thus, the present invention relates to a new optically transparent electrode (OTE) material, electrically conducting diamond thin film, with improved stability, a wider optically transparent range (UV to IR), a wider working potential electrode in aqueous media and controllable surface chemistry (i.e., ease of chemical modification), as compared to current commercial OTE's. Four types of diamond OTEs can be used for transmission measurements: freestanding discs, films deposited on quartz, films deposited on undoped silicon and films deposited on “white” diamond. Additionally, a diamond film deposited on a silicon attenuated total reflection element can be used for reflection on measurements.

The most common OTE commercially available is indium-doped tin oxide (ITO). Diamond OTEs have several superior properties to ITO, such as a wider working potential electrode in aqueous electrolyte solutions, better morphological and microstructural stability allowing for the possible use of this material in harsh chemical environments, a wider optically transparent electrode, a resistance to adsorption of polar molecules that makes the surface less prone to fouling and a rich surface chemistry that can be controlled through chemical derivatization. The electrochemical and optical properties of diamond can be selectively tuned over a wide range through adjustments in the deposition conditions. The optical throughput can be in the visible and infrared regions of the electromagnetic spectrum. The new OTE's can find use in harsh chemical environments (extremes in pH, temperature, etc.). Another possible market is laboratory-on-a-chip devices that employ electro-optical detection for chemical analysis. Still another market is electrode windows for solar cells.

The steps required in preparing a diamond OTE depend on the type. The simplest protocol used for the deposition of a thin film of conductive diamond on undoped silicon, and is described below. A similar protocol was used for the deposition of diamond on quartz and “white” diamond.

a. Wash and clean the substrate in a series of organic solvents and ultrapure water.

b. Soak the substrate in concentrated hydrofluoric acid for 60 seconds followed by a thorough rinsing with ultrapure water.

c. Ultrasonicate the substrate in a dilute solution of diamond powder (0.1 μm diameter or less) and acetone for 20 minutes followed by a thorough washing with acetone. This process seeds the surface with diamond particles that serve as nucleation sites for diamond deposition.

d. Place the substrates in the chemical vapor deposition reactor on top of a molybdenum stage. In the cases where boron doping is performed, the substrates are placed on a ceramic boron diffusion source and adjacent to a piece of boron nitride. Diborane gas, diluted with hydrogen gas, is another source of the doping element.

e. The reactor is pumped down for at least 15 hours to a base pressure of 10-20 mtorr.

f. The substrates are heated to approximately 850° C. in atomic hydrogen for approximately 10 minutes. The plasma is formed with the following conditions: 1000 w of microwave power, an ultrapure hydrogen gas flow of 200 standard cubic centimeters per minute (sccm) and a system pressure of 40-60 torr.

g. The substrates are then exposed to a 2% methane/hydrogen plasma for approximately 10 minutes to nucleate diamond crystals on the surface. The plasma is formed with the following conditions: 1000 W of microwave power, an ultrapure hydrogen gas flow of 200 sccm, an ultrapure methane flow of 4.0 sccm and a system pressure of 40-60 torr.

h. Diamond growth is then continued for approximately 20 hours using a 0.35% methane/hydrogen ratio. All other conditions remain the same as listed in “g”.

The objective of the process is to optimize the electrochemical behavior while maximizing the optical throughput in the visible and infrared regions of the electromagnetic spectrum. The deposition parameters include the methane/hydrogen ratio, boron-doping level, film thickness, and the like.

In summary, electrically conducting and optically transparent diamond thin film electrodes have been developed for use in chemical sensing and detection. Diamond optically transparent electrodes (OTE's) offer advantages over commercial OTE's (e.g., ITO) such as a wider optically transparent range extending from the near ultraviolet (ca. 225 nm) out to the far-infrared (<1000 cm⁻¹) region of the electromagnetic spectrum, a wider working potential electrode in aqueous electrolyte solutions, better morphological and microstructural stability allowing for the material's use in harsh chemical environments, resistance to the adsorption of polar molecules leading to less susceptibility to electrode fouling and controllable surface properties through chemical modification. In general, the boron-doped diamond thin film OTE's are deposited by microwave-assisted chemical vapor deposition using a 0.35% methane/hydrogen ratio, a microwave power of 1000 W, a system pressure of 40-60 torr and a substrate temperature of approximately 875° C. Four types of diamond OTE's are being developed for transmission measurements: freestanding discs, films deposited on quartz, films deposited on undoped silicon and films deposited on “white” diamond. Additionally, a diamond film deposited on a silicon attenuated total reflection element is being developed for reflection measurements.

### EXAMPLE 1

In particular Example 1 relates to diamond optically transparent electrodes with Ferri/Ferrocyanide and Methyl Viologen.

An optically transparent electrode is used on an electrically conductive diamond disc. The electrode was free-standing (0.38 mm thick and 8 mm in diameter), mechanically polished to a 7-nm rms roughness over a 10-μm linear distance, boron-doped (0.05% B/C in the reactant gas mixture), and mounted in a thin-layer transmission cell. The electrode has a short-wavelength cutoff of ˜225 nm, which is the indirect band gap of the material, and transmits light out to at least 1000 nm. In theory, the electrode has an optical electrode from 225 nm well out into the far-infrared, except for the boron acceptor band and the intrinsic multiphonon absorptions. The electrode was used to electrooxidize ferrocyanide to ferricyanide, and the absorbance change associated with the formation of the oxidized product (λₘₐₓ=420 nm) was spectroscopically monitored. The electrode was also used to electroreduce methyl viologen (MV²⁺) to the cation radical (MV^{+o}) and the neutral (MV^{o}). The depletion of MV²⁺ (λₘₐₓ=257 nm) and formation of MV^{+o} (λₘₐₓ=398 and 605 nm) were spectroscopically monitored.

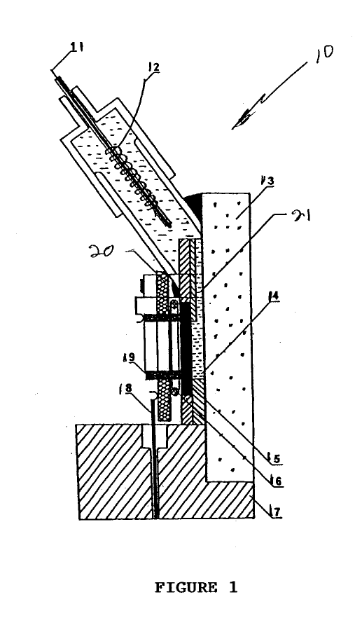

The diamond film was deposited by microwave-assisted CVD on a tungsten substrate using a CH₄/H₂/B₂H₆ gas mixture. The diamond film was then lifted off the substrate and mechanically polished smooth (surface roughness was −7-nm rms over a 10-μm linear distance, as determined by AFM). The free-standing film was blue due to the boron-doping, 380 μm thick and 8 mm in diameter. The electrode was mounted in a specially designed, thin-layer transmission cell shown in FIG. 1, and the electrooxidation of ferrocyanide to produce absorbing (visible region) ferricyanide and the optical changes associated with the reduction of methyl viologen (MV^{2+/+}) to the cation radical (MV^{+o}) and the neutral (MV^{o}) were used to test the properties of this new type of OTE. Diamond offers several advantages over other OTEs including the following: (i) a wide optical electrode from the UV into the IR, (ii) remarkable stability of the electrode in both aqueous (acidic and alkaline) and nonaqueous media, although the surface termination can be slowly changed from hydrogen to oxygen during exposure to acidic solutions, and, more importantly, (iii) the fact that a good knowledge base has been developed in recent years regarding how the bulk and surface properties influence the electrochemical kinetics of various redox reactions (Granger, M. C., et al., Anal. Chim. Acta 397 145 (1999); and Granger, M. C., et al., Anal. Chem. 72 3793 (2000)). Even though ITO, for example, has been used extensively during the past two decades in spectroelectrochemical measurements, a much better understanding of structure-function relationships may presently exist for diamond. This should lead to better reproducibility with diamond in spectroelectrochemical measurements.

Experimental Section

A boron-doped diamond disk was used as the OTE (reference lot no. NRL148). It had a diameter of 8 mm and a thickness of 380 μm. The free-standing, polycrystalline diamond disk was grown by microwave plasma CVD (2.45 GHz) in a customized reactor at the Naval Research Laboratory, based on the 5-kW ASTeX model 5400. The reactants were hydrogen purified using a Pd diffusion cell, ultrahigh purity CH₄, and O₂ (when used), and ¹⁰B₂H₆ prediluted in hydrogen. The reactor pressure and reactant flow rates were controlled and monitored using a computer system. The reactor was modified for independent substrate temperature control, direct measurement of substrate surface temperature using a two-color pyrometer, optical emission spectroscopy, and residual exhaust gas analysis. Samples were grown on 2-in diameter refractory metal substrates (W or Mo) which released free-standing plates of CVD diamond on cooling from the deposition temperature. Nucleation was assisted by polishing the substrate with 0.25-μm diamond powder prior to insertion into the reactor. The substrate temperature was controlled during the growth by varying the gas pressure in a 75-μm gap between the substrate holder and a water-cooled backing plate. The substrate temperature was measured using a two-color pyrometer (2.1 and 2.4 μm, Williamson, model 8200) viewing through a 7-mm hole in the microwave applicator and the fused-silica microwave electrode. The diamond plate was subsequently laser machined to the appropriate sample size and cleaned in various boiling acids, usually aqua regia followed by a mixture of concentrated sulfuric and nitric acid. The sample was then mechanically polished using a resin-bonded diamond wheel (Coburn Eng. Co. Ltd., Romford, Essex, England).

The specific growth conditions were a tungsten substrate at 8100C, reactor pressure of 117 Torr, 5.0 kW of microwave power, and gas flows of 115 sccm for H₂, 8 sccm for CH₄, and 0.4 sccm of 0.1% ¹⁰B₂H₆ in H₂. AFM measurements revealed that the polished surface is smooth with a typical root-mean-square roughness of 7 nm over a 10-μm linear distance. The AFM measurements were made using a Nanoscope E (Digital Instruments, Santa Barbara, Calif.) working in the contact mode. The D-type scanning head (12 μm) was used in the measurements along with a silicon nitride probe tip with a 0.12 N/m spring constant.

The diamond disk was mounted in a cell 10 that is shown schematically in FIG. 1. The body of the cell consists of a quartz plate 13 with an attached metal base 17 fitting a standard cuvette holder for a UV/visible spectrophotometer. The thin-layer cavity 14 of the cell is formed between the diamond OTE 15 and the quartz plate using a 0.3-mm spacer made of Teflon sticky tape (not shown). Another layer of the Teflon tape (not shown) with an opening the size of the diamond disk is used to position it in the cell. An O-ring 16 and a metal washer 20 held with a spring rod 18, press the electrode against the Teflon spacer. Electrical contact with the diamond disk was made with a rolled piece of Pt foil 19 in a springloaded clamp. A small channel 21 was cut in the Teflon spacer to connect the thin-layer cavity with a compartment containing the reference and counter electrodes 11 and 12. These electrodes were mounted in a rubber septum that sealed the cell when filled with solution. A pseudoreference electrode made of Ag wire coated with a NAFION film (Aldrich Chemical Co.) was used. Its potential in 1 M KCl or NaCl was ˜−40 mV vs Ag/AgCl/KCL (saturated) reference electrode. A coil made of Pt wire was used as the counter electrode. The solution was introduced into the cell using a syringe, and care was used to avoid trapping air bubbles in the closed space of the thin-layer cavity or in the counter/reference electrode compartment. The active portion of the diamond OTE was defined by the opening in the Teflon spacer. This opening was 7 mm in diameter giving an exposed geometric area of 0.39 cm². Some measurements were also performed with the diamond OTE mounted in a conventional, single-compartment glass electrochemical cell (Granger, M. C., et al., Anal. Chem. 72 3793 (2000)). In such experiments, the potentials were measured against a Ag/AgCl (saturated KCl) reference electrode.

The thin-layer transmission cell was mounted in the cuvette holder of double-beam Shimadzu UV2401PCT spectrophotometer. This instrument was housed in the Shimadzu-USU Analytical Sciences Laboratory at Utah State University. All spectra presented as spectroelectrochemical data were corrected for diamond electrode absorbance by subtracting the spectrum obtained for the electrode mounted in the cell containing only the supporting electrolyte. An OMNI 90 (Cypress Systems, Inc., Lawrence, Kans.) analog potentiostat was used to control the applied potential. The current-voltage curves were recorded with a Linseis 1800 X-Y-T recorder.

Methyl viologen dichloride hydrate (1,1′-dimethyl-4,4′-bipyridinium dichloride, Aldrich), potassium ferrocyanide (Aldrich), KCl (Fisher Scientific), and NaCl (Fisher Scientific) were used as received without additional pretreatment. All solutions were prepared using purified deionized water with a resistivity of greater than 17.5 MΩ. The solutions were usually purged with argon for at least 16 min prior to filling the cell.

Results and Discussion

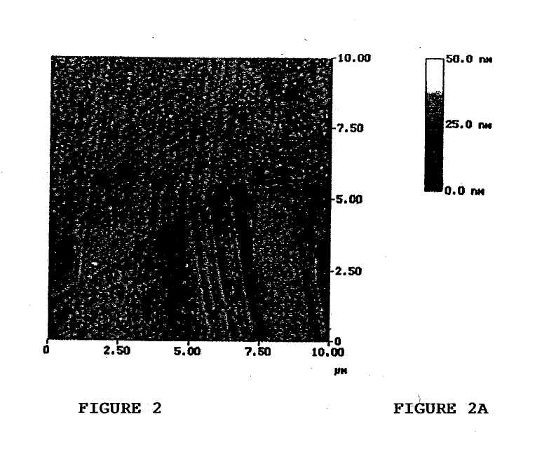

FIG. 2 shows a contact mode (air) AFM image (10×10 μm²) of the polished electrode surface. A SEM image of an electrode from the same batch, prior to polishing, was recently presented (Granger, M. C., et al., Anal. Chem. 72 3793 (2000)). That image revealed the characteristic large-grain, polycrystalline growth sectors. It can be seen that the polished surface is relatively smooth and is no longer bound by the growth facets of the large-grained (˜40-μm diameter) crystallites (Granger, M. C., et al., Anal. Chem. 72 3793 (2000)). The image reveals grooves running from top to bottom. These are presumably the striations caused by the polishing. There is also an apparent grain boundary running from the lower left to the upper right of the image. This would appear to be the junction of two polished grains. A 10-μm line profile across the center of the image revealed a root-mean-square roughness of 7 nm with a maximum height change of 23 nm.

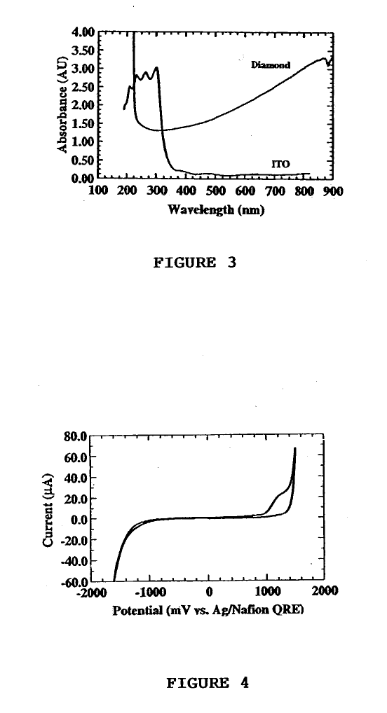

FIG. 3 presents a comparison of the relative absorbance spectra from 200 to 800 nm for the diamond OTE and a sample of ITO coated on glass. No corrections have been made for any scattering or reflection losses. The ITO (Nesatron Co.) had a relatively constant absorbance from 400 to 800 nm, transmitting ˜63% of the light (0.2 AU). The cutoff at 330 nm is presumably due to absorption by the glass substrate the ITO was coated on. The spectrum for the diamond OTE has a cutoff at 225 nm due to band gap absorption. There is a general trend of increasing absorption with increasing wavelength between 500 and 800 nm. The relative absorbance in this region very much depends on the film quality (defects and impurities), reflection losses, doping level, and film thickness. These parameters will be adjusted in future work in an effort to increase the level of transmitted light over this wavelength range. For example, in very recent work, the optical absorption of boron-doped, polycrystalline diamond (unpolished) deposited on quartz was examined. The 1000-nm absorbance of films (same approximate thickness) deposited from 0.5% CH₄/H₂ plus 10 and 2 ppm B₂H₆, respectively, was 3.8 and 2.8. The absorbance at the same wavelength of films deposited for 12 and 10 h, respectively, from 0.5% CH₄/H₂ plus 2 ppm B₂H₆ was 2.8 and 1.8. These preliminary observations demonstrate that the optical properties can be manipulated by adjusting the growth conditions.

FIG. 4 shows a background cyclic voltammetric i-E curve for the diamond OTE recorded in 0.1 M KCl. The measurement was made at 0.1 V/s in a conventional glass electrochemical cell. Similarly shaped curves were also obtained in the thin-layer cell. A wide window of useful electrode potentials ranging from about −1.5 to 1.5 V is evident. This is characteristic of boron-doped polycrystalline diamond electrodes, although the absolute magnitude of the electrode (3 V) is a little less than typically observed (Xu, J., et al., Anal. Chem. 69 591A (1997); Swain, G. M., et al., MRS Bull. 23 56 (1998); Granger, M. C., et al., Anal. Chim. Acta 397 145 (1999); and Granger, M. C., et al., Anal. Chem. 72 3793 (2000)). There is some anodic charge centered at ˜1200 mV just prior to the onset current for oxygen evolution. This is likely due to the oxidation of reaction sp³ and sp² carbon (e.g., dangling bonds and polishing debris) remaining on the surface after mechanical polishing (Granger, M. C., et al., Anal. Chim. Acta 397 145 (1999); Granger, M. C., et al., Anal. Chem. 72 3793 (2000); and Martin, H. B., et al., J. Electrochem. Soc. 143 L133 (1996)). This reactive carbon can be effectively removed by acid washing and subsequent hydrogen plasma treatment, although such a pretreatment was not applied to the present electrode (Granger, M. C., et al., Anal. Chem. 72 3793 (2000)). Low levels of sp² carbon impurities may be one of the reasons for the optical absorbance between 500 and 800 nm. Both the electrochemical properties shown here and the optical features presented in FIG. 3 indicate that diamond has the potential to be a useful electrode material for spectroelectrochemical measurements in the visible and near-UV regions of the spectrum.

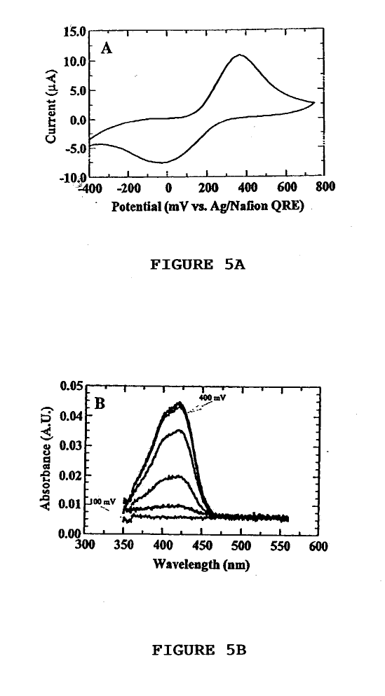

The diamond OTE was first tested using the ferri-ferrocyanide redox system. A cyclic voltammetric i-E curve for 1 mM Fe(CN)₆⁴⁻ in 1 M KCl at 2 mV/s is shown in FIG. 5A. The measurement was made in the thin-layer transmission cell, and the low scan rate was used to minimize ohmic distortion of the voltammogram. The electrochemical kinetics of this redox system are quite sensitive to the surface cleanliness and functional group termination on diamond (Granger, M. C., et al., Anal. Chem. 72 3793 (2000); and Granger, M. C., et al., J. Electrochem. Soc. 146 4551 (1999)). For example, Granger and Swain showed that the electrochemical kinetics of Fe(CN)₆^{3-/4-} are strongly decreased when the surface termination changes from hydrogen to oxygen (Granger, M. C., et al., J. Electrochem. Soc. 146 4551 (1999)). This redox system undergoes a reversible 1-electron transfer according to the following reaction:

Fe(CN)₆⁴⁻ [symbol] Fe(CN)₆³⁻+e^{-(colorless) (yellow)}

The ΔEₚ is rather large at 425 mV even at the slow scan rate. This is due to the ohmic resistance in the cell and the surface oxygen present on the electrode. This electrode was employed in a number of anodic polarization measurements prior to use in these spectroelectrochemical studies. Therefore, the surface contained significant levels of surface carbon-oxygen functionalities. The voltammetric peak charge was used to estimate the optical path length and the volume of the thin-layer cavity in the cell. This first-generation cell was intentionally designed with a relatively large cell volume in order to increase the optical path length. A tradeoff for the increased absorbance is the longer equilibration time required (i.e., complete electrolysis) at a given potential. Also, the shapes of the voltammetric curves at short times will still have a diffusional component because the depletion layer thickness is less than the cell thickness. In this particular case, there does appear to be postpeak current decay characteristic of semi-infinite linear diffusion, although no detailed scan rate dependence studies were performed to investigate this more thoroughly. The estimated volume, V, of the solution layer in the present cell was found to be 13.5 μL. This is based on the background-corrected oxidation and reduction peak charges and considering that V=Q/nFC_{bulk} for a thin-layer cell, where the charge, Q, is equal 1.3±5% mC at the ferrocyanide concentration, C, of 1.0 mM. The thickness of the solution layer was estimated to be 0.0346 cm by dividing the cell volume (13.5 μL or 0.0135 cm³) by the geometric area of the electrode (0.39 cm²). It should be emphasized that this value is only an estimate since the voltammetric response is not characteristic of pure thin-layer behavior but has a contribution from semi-infinite linear diffusion. More reliable is the same parameter calculated from the spectral data. Taking into account that a maximum absorbance for the fully oxidized form of the solution species at 420 nm is equal 0.035 absorption units, a value of 0.0343 cm was calculated for the optical path length (b=A/εC). The value of the molar absorptivity, ε, of 1020 L/mol·cm used here for ferricyanide in 1 M KCl was determined from separate measurements and also reported in the literature (Shi, Y., et al., Anal. Chem. 69 4819 (1997)).

FIG. 5B shows a series of spectra recorded for the electrooxidation of 1 mM Fe(CN)₆⁴⁻ in 1 M KCL at potentials between 100 and 400 mV. The range covers the states of the solution species from the transparent reduced form, which exists at 100 mV, to the absorbing (λₘₐₓ=420 nm) oxidized form, which is completely achieved at 400 mV. Each spectrum at a given potential was recorded only when two successive spectra were identical. This indicated that equilibrium had been achieved in the cell. Equilibrium was reached in ˜10 min at each potential. The broad absorbance increases with increasing positive potential up to 400 mV after which no additional increases are seen as the analyte in the cell was completely electrolyzed. The optical absorbance trends were completely reversible if the potential was stepped in the cathodic direction to form the transparent (at 420 nm) ferrocyanide. The spectra were also fully reproducible with multiple cycles demonstrating the stability and usefulness of the diamond OTE in spectroelectrochemistry.

The use of the diamond OTE was also demonstrated for the reduction of methyl viologen (MV²⁺), a compound that has been the focus of numerous studies over the years (Osa, T., et al., J. Electroanal. Chem. Interfacial Electrochem. 22 389 (1969); Landrum, H. L., et al., J. Am. Chem. Soc. 99 3154 (1977); Cieslinski, R. C., et al., J. Electrochem. Soc. 127 2605 (1980); Bowden, E. F., et al., J. Electroanal. Chem. 125 367 (1981); Stargardt, J. F., et al., Anal. Chim. Acta 146 1 (1983); White, J. R., et al., J. Electroanal. Chem. 197 233 (1986); Bird, C. L., et al., Chem. Soc. Rev. 10 49 (1991); Engelman, E. E., et al., Langmuir 8 1637 (1992); Engelman, E. E., et al., J. Electroanal. Chem. 349 141 (1993); Yang, H.-H., et al., Anal., Chem. 71 4081 (1999); Lee, C., et al., J. Electroanal. Chem. 463 224 (1999); and Feng, Q., et al., J. Phys. Chem. 94 2082 (199)). This redox analyte undergoes a reversible 2-electron redox reaction according to the following scheme:

$$\begin{matrix}{{MV}^{ 2 +}}_{( colorless ) } + {e}^{-} ⇆ {{MV}^{ + \cdot }}_{( violet )} & ( R1 ) \\ {MV}^{ + \cdot } + {e}^{-} ⇆ {{MV}^{ 0}}_{( yellow / brown )} & ( R2 )\end{matrix}$$

The electrochemical reaction kinetics are relatively insensitive to the diamond surface structure and chemistry (Granger, M. C., et al., Anal. Chim. Acta 397 145 (1999); Granger, M. C., et al., Anal. Chem. 72 3793 (2000); and Wang J., et al., New Diamond Frontier Carbon Technol. 9 317 (1999)). The main factor influencing the kinetics is the local density of electronic states at the formal potentials of the redox reactions (Granger, M. C., et al., Anal. Chem. 72 3793 (2000)). The neutral form, MV^{o}, is often electrodeposited in aqueous media because of its hydrophobic character. This generally occurs at solution concentrations of 0.5 mM or greater. Disproportionation and conproportionation reactions can also occur which affect the peak heights and shapes of the cyclic voltammetric i-E curves (Bird, C. L., et al., Chem. Soc. Rev. 10 49 (1991); Engelman, E. E., et al., Langmuir 8 1637 (1992); and Engelman, E. E., et al., J. Electroanal. Chem. 349 141 (1993)).

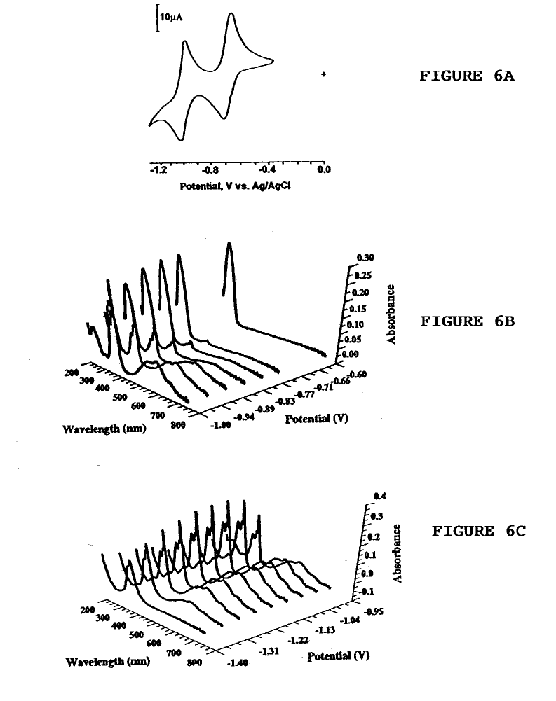

A typical cyclic voltammetric i-E curve for 0.5 mM MV²⁺ in 1 M NaCl at the diamond OTE is shown in FIG. 6A. The measurement was made in conventional glass electrochemical cell at a scan rate of 50 mV/s. Reduction peaks are seen at −705 and −1020 mV corresponding to the formation of MV^{+o} and MV^{o}, respectively. On the reverse scan, these two products are reversibly oxidized at potentials −970 and −635 mV, respectively. The corresponding ΔEₚ values are 70 and 50 mV for the MV²⁺/MV^{+o} and MV^{+o}/MV^{o} couples. The peak shapes are characteristic of diffusion-controlled reactions, and the peak current ratios for both are near 1, indicating that the deposition of MV^{o} is not occurring to any measurable extent. This voltammetric response is similar to previously reported data for this redox system (Granger, M. C., et al., Anal. Chim. Acta 397 145 (1999); Granger, M. C., et al., Anal. Chem. 72 3793 (2000); and Wang, J., et al., New Diamond Frontier Carbon Technol. 9 317 (1999)).

With the diamond OTE mounted in the thin-layer transmission cell, the reduction of MV²⁺ to MV^{+o} and MV^{o} was performed chronoamperometrically every 50 mV between −600 and −1400 mV. Recall that these potentials are measured versus the Ag/Nafion pseudoreference electrode. FIG. 6B shows a series of spectra obtained at different potentials for the MV²⁺/MV^{+o} redox reaction. The spectrum shown for −0.60 V is the same as that obtained at the open circuit potential and all other potentials positive of −0.65 V. This spectrum shows only the 257-nm absorbance characteristic of MV²⁺ (Landrum, H. L., J. Am. Chem. Soc. 99 3154 (1977); Bowden, E. F., et al., J. Electroanal. Chem. 125 367 (1981); and Stargardt, J. F., et al., Anal. Chim. Acta 146 1 (1983)). The absorbance, A=0.283, allows one to calculate a molar absorptivity, ε, of 1.62×10⁴ L/mol·cm. This value is in good agreement with that determined from separate measurements of neat MV²⁺ solutions which was 1.75 (±0.05)×10⁴, and the value of 2.07×10⁴ L/mol·cm reported by Stargardt and Hawkridge (Stargardt, J. F., et al., Anal. Chim. Acta 146 1 (1983)). Beginning at −0.75 V, a new absorbance maximum appears at 398 nm, which continuously grows, together with another maximum at 605 nm as the applied potential becomes more negative. The broad absorbance centered at 398 nm actually has some fine structure with peaks also observed at 388 and 374 nm. The relative intensity ratios of these three peaks remains constant at all potentials, but the absolute magnitude of the broad absorbance increases with increasing negative potential. The 398- and 605-nm central absorbences are associated with the formation of MV^{+o} (Osa, T., et al., J. Electroanal. Chem. Interfacial Electrochem. 22 389 (1969); Landrum, H. L., et al., J. Am. Chem. Soc. 99 3154 (1977); Bowden, E. F., et al., J. Electroanal. Chem. 125 367 (1981); and Stargardt, J. F., et al., Anal. Chim. Acta 146 1 (1983)). The 257-nm absorbance maximum for MV²⁺ shows a corresponding decrease over this potential range, as expected as this species is depleted with the formation of MV^{+o}. At −1.00 V, ˜15% of the original concentration of MV²⁺ remains in solution, based on the absorbance maximum change. This is probably due to the incomplete electrolysis of MV²⁺ in the large cell volume. At this point, when the reaction is reversed by applying a sequence of potentials in the positive direction, it is possible to completely restore the 257-nm absorbance for MV²⁺ and to eliminate the 398- and 605-nm absorption bands for MV^{+o}.

FIG. 6C shows a series of spectra obtained at potentials from −1.0 to −1.4 V. In this potential region, MV^{+o} and any remaining MV²⁺ are reduced to MV^{o}. It can be seen that a maximum in the 398- and 605-nm absorption bands for MV^{+o} is reached at −1.10 V. At the same time, the 257-nm absorption band for MV²⁺ completely disappears. The formation of MV^{o} that is progressing with increasing negative potential is observed by the gradually decreasing 398- and 605-nm bands. The spectrum recorded at −1.40 V contains only one absorption band at 398 nm, with less fine structure, characteristic of MV^{o} (Feng, Q., et al., J. Phys. Chem. 94 2082 (1990)).

It is important to note that the conditions of the experiment in the thin-layer cell are different from those in a conventional electrochemical cell. This is due to the conproportionation reaction that can occur

MV^{o}+MV²⁺→2MV^{+o}

In the thin-layer cell, where the MV²⁺ concentration would be negligible due to the complete electrolysis, the MV^{o} formed cannot be chemically converted to MV^{+o}. Therefore, the absorbance-potential curves are completely reversible with cycling. The effect of this reaction step is clearly seen in cyclic voltammetric i-E curves recorded in a conventional cell at slow scan rates (Granger, M. C., et al., J. Electrochem. Soc. 146 4551 (1999)). A large peak is observed for the second oxidation reaction, MV^{o+}→MV²⁺, while the peak for the first oxidation reaction, MV^{o}→MV^{+o}, is non-existent. The reversibility of the absorbance-potential curves can also be influenced by the deposition of insoluble MV^{o}. If amorphous or crystalline deposits form, then less MV^{o} is available for the reverse (oxidation) process. In the present case, deposition of MV^{o} was minimal as the absorbance-potential curves were completely reversible with potential cycling.

### CONCLUSIONS

The use of boron-doped diamond as an optically transparent electrode was demonstrated. The electrode was mounted in a specially designed, thin-layer transmission cell and the electrooxidation of ferrocyanide to produce the light absorbing ferricyanide, and the optical changes associated with the reduction of methyl viologen (MV^{2+/+}) to the cation radical (MV^{+o}) and the neutral (MV^{o}) were used to demonstrate the practical application of this new type of OTE. Diamond offers a wide useful spectral electrode in addition to all the important electrochemical properties of the material like the wide working potential electrode, the low voltammetric background current, and the structural stability. Obvious modifications involve manipulation of the deposition conditions in order to maximize the optical throughput in the visible and infrared portions of the electromagnetic spectrum and the quantitative and mechanistic studies of various aqueous and nonaqueous redox systems.

### EXAMPLE 2

This example shows the optical and electrochemical properties of optically transparent, boron-doped diamond thin films deposited on quartz.

The optical and electrochemical properties of transparent, boron-doped diamond thin film, deposited on quartz, are described. The films were deposited by microwave-assisted chemical vapor deposition, for 1-2 h, using a 0.5% CH₄H₂ source gas mixture at 45 Torr and 600 W of power. A high rate of diamond nucleation was achieved by mechanically scratching the quartz. This pretreatment leads to the formation of a continuous film, in a short period of time, which consists of nanometer-sized grains of diamond. The thin-film electrode was characterized by cyclic voltammetry, atomic force microcopy, and UV-visible absorption spectrophotometry. The film's electrochemical response was evaluated using Ru(NH₃)₆^{3+/2+} in 1 M KCl, Fe(CN)₆^{3-/4-} in 1 M KCl, and chlorpromazine (CPZ) in 10 mM HClO₄. The film exhibited a low voltammetric background current and a stable and active voltammetric response for all three redox systems. The optical transparency of the polycrystalline film in the visible region was near 50% and fairly constant between 300 and 800 nm. The optical and electrical properties were extremely stable during 48-h exposure tests in various aqueous (HNO₃, NaOH) solutions and nonaqueous (e.g., chlorinated) solvents. The properties were also extremely stable during anodic and cathodic potential cycling in harsh aqueous environments. This stability is in stark contrast to what was observed for an indium-doped tin oxide thin film coated on quartz. The spectroelectrochemical response (transmission mode) for CPZ was studied in detail, using a thin-layer spectroelectrochemical cell. Thin-layer voltammetry, potential step/absorption measurements, and detection analytical figures of merit are presented. The results demonstrate that durable, stable and optically transparent diamond thin films, with low electrical resistivity (˜0.026 Ω.cm) laterally through the film, can be deposited on quartz.

This example shows the optical, electrochemical, and spectroelectrochemical characterization of optically transparent, boron-doped diamond thin film, deposited on quartz. The results demonstrate that highly conducting, durable, and optically transparent diamond films can be reproducibly deposited on this substrate. The films possess a transmittance of 40-50% between 300 and 800 n. Good electrode responsiveness is shown for chlorpromazine (CPZ), Ru(NH₃)₆^{3+/2+} and Fe(CN)₆^{3-/4-} without any electrode pretreatment.

The electrical and optical properties are highly stable during exposure to strongly acidic and alkaline solutions, as well as to common organic solvents. The properties are also stable during anodic and cathodic polarization in strongly acid media. This stability is in stark contrast to what is observed for ITO during the same solution exposures and polarizations. Transmission spectroelectrochemical measurements were conducted in a home-made thin-layer cell to demonstrate the film's usefulness as an OTE. Thin-layer voltammetry, potential-step/absorption measurements, and detection analytical figures of merit are presented for CPZ in 10 mM HClO₄. The results presented portend the possibility of also growing these electrically conductive and transparent films on quartz waveguides and optical fibers for use in electrooptical sensors and detectors.

Experimental Section

Film Deposition. The quartz substrate (1×1×0.1 cm³) was prepared by mechanically scratching one side of the substrate with 0.1-μm diamond powder slurried in ultrapure water. After scratching, the diamond powder was removed through consecutive 5-min ultrasonications in ultrapure water, 2-propanol, acetone, 2-propanol, and ultrapure water. The substrate was then dried under a stream of nitrogen. A boron-doped film was deposited on the scratched quartz with a CH₄/H₂ volumetric ratio of 0.5%, 10 ppm B₂H₆ dopant, a total gas flow of 100 sccm, a gas pressure of 45 Torr, and microwave power of 600 W. The substrate temperature during deposition was estimated to be 800° C., using an optical pyrometer. The growth time was either 1 or 2 h, followed by a 10-min hydrogen plasma treatment at 600 W and 45 Torr. This postgrowth treatment was applied to remove any adventitious sp²-bonded non-diamond carbon impurities and to hydrogen terminate the surface. The films were then cooled over a 2-min period by gradually reducing the power and pressure of the hydrogen plasma to 400 W and 10 Torr. The resulting films were 1 cm² and estimated to be ˜500 nm in thickness after 1-h growth and ˜1000 nm after 2-h growth.

Optical Measurements. The diamond and ITO OTEs were rinsed with distilled 2-propanol (IPA) and allowed to dry in air, prior to making any optical measurements. The electrodes were mounted vertically for UV-visible measurements and were placed orthogonal to and facing the incident light. The electrodes were held in place over the aperture of the sample holder, using a small piece of double-sided adhesive tape along one edge. The spectrum for an uncoated and unscratched quartz substrate cleaned in the same manner, was used as the background. UV-visible spectra were recorded with a computer-controlled Shimadzu UV-2401 PC spectrophotometer (Shimadzu Corp., Columbia, Md.), using a slit width of 5 nm and a 210 nm/min scan rate.

Electrochemical Measurements in the Standard Glass Electrochemical Cell. Electrochemical measurements were made with a computer-controlled potentiostat (model 650A, CH Instruments, Inc., Austin, Tex.) in a three-electrode configuration. No iR correction was used in any of the reported measurements. The electrodes were clamped over the bottom opening of a three-necked, glass electrochemical cell (Granger, M. C., et al., Anal. Chem. 72 3793-3804 (2000)). A Viton O-ring (i.d. 0.5 cm), placed between the cell opening and the electrode surface, ensured that a controlled nominal surface area of 0.2 cm² was exposed to electrolyte solution. Contact was made to the working electrode by pressing a piece of nickel foil on the surface. The foil was roughly the size of the electrode with a portion in the center removed just larger in diameter than the O-ring. A spacer was cut from a rubber sheet to the same dimensions of the nickel foil and was used to press the foil against the electrode surface. The O-ring was sonicated for 10 min in ultrapure water, rinsed with distilled IPA, and dried under a stream of nitrogen gas (before mounting a diamond electrode in the cell). Once mounted in the cell, the electrode was exposed to IPA and allowed to soak for 30 min. The electrode was then rinsed thoroughly with distilled water, and the cell was filled with the electrolyte solution of interest. Nitrogen was bubbled through the solution for 10 min, to remove dissolved oxygen. All measurements were made with the solution blanketed by a stream of nitrogen. The auxiliary electrode was a large-area carbon rod, and the reference was a commercial Ag/AgCl electrode filled with a 4 M KCl saturated with AgCl. Both the auxiliary and reference electrodes were placed in fritted capillaries filled with the supporting electrolyte. The frit for the auxiliary electrode did not add significant resistance to the flow of current through the cell, as cyclic voltammograms for Ru(NH₃)₆^{3+/2+}, measured with and without the frit, were identically shaped.

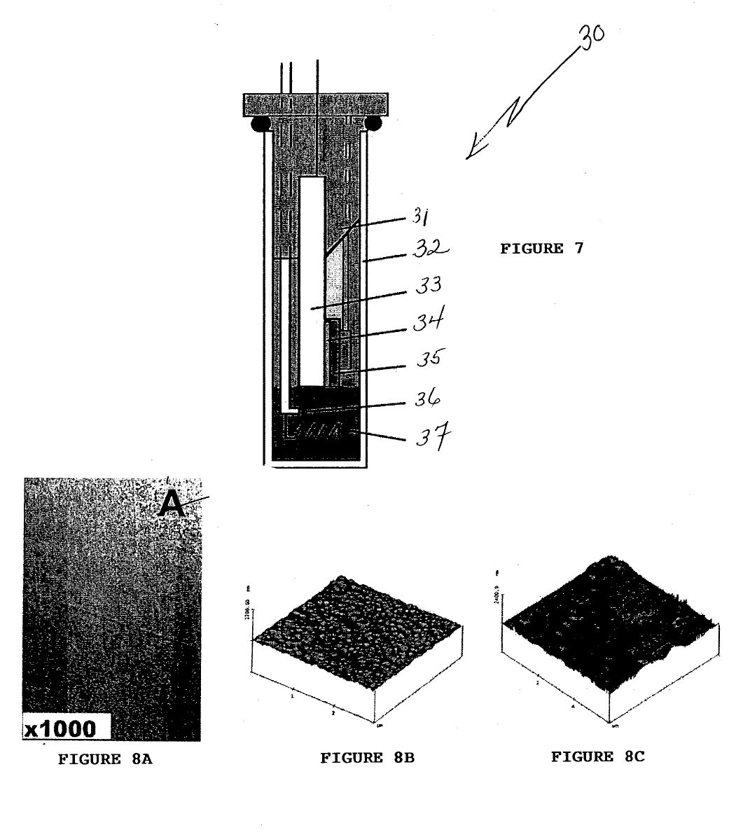

Spectroelectrochemical Measurements in the Thin-Layer Cell. Cyclic voltammetric and potential-step/absorption measurements were carried out in a thin-layer cell. The design of the cell is shown in FIG. 7. The main body of the cell was constructed with Kel-F plastic and optical-quality quartz. The entire body fits in a standard 10×10 mm quartz cuvette. A silicone rubber gasket, placed between the quartz insert and electrode surface, creates a thin-layer cavity ˜150 μm thick with a volume of 4.8 μL. Electrical contact was made by pressing a complete edge of the electrode surface, unexposed to electrolyte solution, onto a Pt wire, which extended to the outside of the cell. Another coil of Pt wire was used as the auxiliary electrode, and Ag wire was used as a quasi-reference electrode (QRE). The thin-layer cavity was open at the bottom, allowing it to be filled with electrolyte solution through capillary action when the quartz cuvette is partially filled with solution. The auxiliary and reference electrodes were positioned in the electrolyte solution (below the cell insert) in the assembled and filled cell.

Soaking Experiments with Indium-Doped Tin Oxide Films. ITO films with a nominal thickness of 20 nm and a resistivity of 3.7×10⁻⁵ Ω·cm, deposited on fused quartz microscope slides (Delta Technologies, Limited, Stillwater, Minn.), were cut into ˜1 cm² pieces by scoring along the uncoated surface and breaking. The pieces were sequentially soaked for ˜48 h in neat toluene (MCB Manufacturing Chemists, Inc., ACS), hexane (Baker, ACS, 97%), methanol (Baker, ACS, 99.8%), dichloromethane (Mallinckrodtkt, ACS), 1 M HNO₃ (Cleveland Chemical Industries, 70% ACS), or 1 M NaOH (Spectrum, ACS). The aqueous solutions were prepared with ultrapure water. The UV-visible transmission spectrum (as described above) and in-plane resistivity were recorded before and after soaking.

Four-Point Probe Measurements. The resistivity of the diamond and ITO films was measured with a tungsten-tip, fourpoint probe connected to an HP 3478A multimeter (Hewlett-Packard, Palo Alto, Calif.), which was operated in the four-wire resistance measurement mode. The probe spacing was 0.1 cm. The measured resistance was converted to resistivity according to the equation (Schroder, D. K. In Semiconductor Material and Device Characterization, John Wiley and Sons: New York, Chapter 1 (1990)),

Rₛ(Ω·cm)=4.532tR(Ω)

where t is the film thickness in centimeters. Six measurements were made at different locations on each film. The nominal resistivity of the diamond OTE was 0.026 Ω·cm.

Atomic Force Microscopy (AFM). Atomic force micrographs were captured in the contact mode (in air) with a Nanoscope IIIa instrument (Digital Instruments/Veeco Metrology Group, Santa Barbara, Calif.), using 200-μm narrow-leg, triangular cantilevers having a spring constant of 0.06 N/m.

Chemicals. KCL (1 M, Mallinckrodt ACS, or Baker ACS, 99.9%), 0.1 M NaOH (Mallinckrodtkt ACS, 99%), and 10 mM HClO⁴ (Aldrich, 70% in water from 99.999%) were each prepared once a week with 18 MΩ ultrapure water from a Barnstead E-pure water purification system. K₄Fe(CN) (Aldrich ACS, 99%), Cl₃Ru— (NH₃)₆ (Aldrich ACS, 98%) in 1 M KCl, and chlorpromazine hydrochloride (Sigma) in 10 mM HCl₄ were all prepared fresh daily.

Results and Discussion

An ideal diamond OTE for UV-visible spectroelectrochemical measurements would be an ultrathin film with a nominal grain size less than the wavelength of light, to minimize light absorption and scattering losses, respectively. Pretreatment of the quartz by uniform scratching is necessary to achieve this type of film. The scratching produces a high nucleation-site density on an otherwise smooth quartz surface with the resulting grooves, if thoroughly cleaned of the polishing debris, serving as the nucleation sites. This is an important step in the deposition process. The high nucleation rate leads to growth of a thin and continuous submicrometer grain film. An optical micrograph of a film grown for 1 h on a scratched substrate is shown in FIG. 8A (collected with a polarization filter). The film is continuous over the surface with no apparent pinholes or void spots. The adhesion is superb, even after handling the electrode, as this one was, for many experiments. Some of the larger scratches on the quartz are visible through the diamond film, indicative of the film's optical clarity. The height-mode AFM image, presented in FIG. 8B, shows a nodular film morphology with features having a nominal diameter of 100-200 nm. In contrast, the height-mode AFM image, presented in FIG. 8C, illustrates the nature of diamond growth on a poorly prepared quartz substrate. Isolated clusters of large diamond grains are seen, and there is certainly no continuous film. This type of growth occurs if the surface is not uniformly scratched or the resulting grooves are not thoroughly cleaned of polishing debris. In this case, the rate of crystal growth exceeds the rate of nucleation, leading to isolated diamond deposition after 4 h.

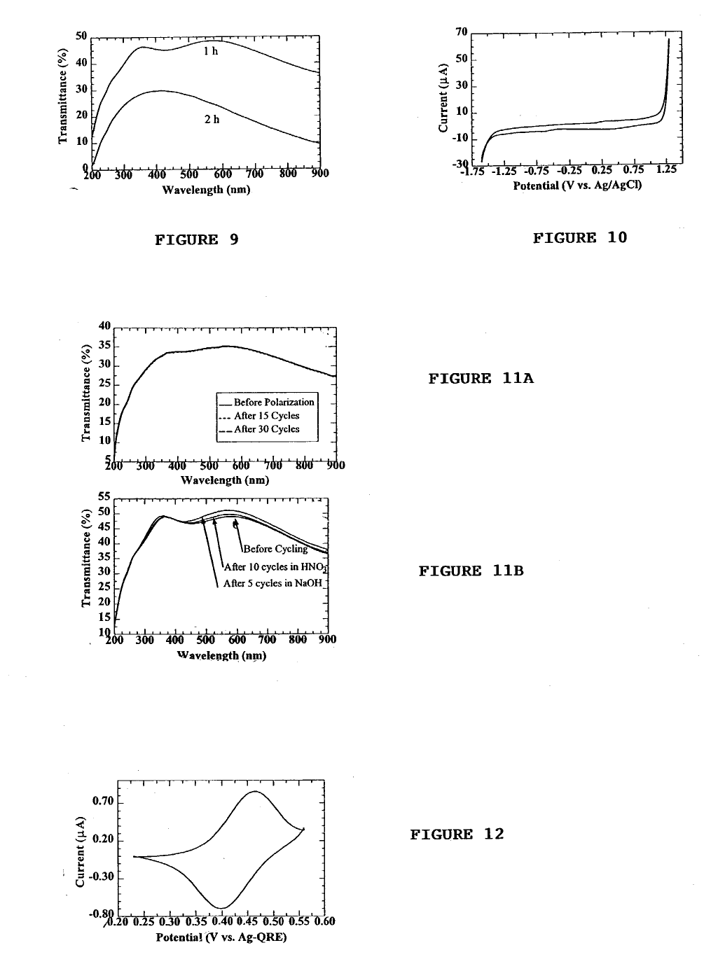

Background-corrected UV-visible transmission spectra for two different diamond films, deposited on quartz, are shown in FIG. 9. The morphology of both films resembles that shown in FIG. 8B. For both the 1- and 2-h films, the transmittance significantly decreases below 300 nm, because of absorption by nitrogen impurities (i.e., electronic transitions from nitrogen impurity levels to the conduction band) and indirect band gap absorption below 225 nm (i.e., electronic transitions from the valence band to the conduction band). Nitrogen is a common impurity in chemical vapor deposition (CVD) diamond arising from either contamination of the source gases or atmospheric leaks into the reactor. The A aggregate of nitrogen, comprising a nearest-neighbor pair of substitutional nitrogen atoms, is the dominant impurity in most natural diamonds (Collins, A. T., J. Phys.: Condens. Matter 14, 3743-3750 (2002). This A aggregate behaves as a deep donor with an ionization energy of 4 eV and may be responsible for the absorption between 225 and 300 nm. The transmittance of the 1-h film is relatively constant at 40-50% between 300 and 800 nm. The 2-h film is thicker and presents a longer path length, hence the reduced transparency. Preliminary measurements indicated that less than 10% of the throughput loss below 400 nm is due to reflectance. Reflectance losses gradually increase to 20% at wavelengths between 600 and 1000 nm. The 1-h film possessed low electrical resistivity (ρ=0.026 Ω·cm) and high optical throughput; consequently, this OTE was used in the spectroelectrochemical measurements discussed below. It should be pointed out that films of this optical and electrical quality can be reproducibly prepared on quartz.

At least five factors can influence diamond's optical transparency in the near-UV and visible regions of the electromagnetic spectrum: (1) the substitutional boron in the lattice, which increases the optical density with a broad absorbance continuum above 600 nm, (2) scattering losses due to the polycrystalline morphology, (3) structural defects (e.g., grain boundaries) containing sp²-bonded carbon and boron, (4) chemical impurities, such as substitutional nitrogen, which result in absorption below 300 nm (Collins, A. T., J. Phys,: Condens. Matter 14 3743-3750 (2002); and Pankove, J. I., et al., In Synthetic Diamond: Emerging CVD Science and Technology, Speark, K. E., Dismukes, J. P., Eds.; Wiley: New York pp 401-418 (1994)) and (5) reflectance losses. The transmission is affected across the spectral region investigated by changes in the effective path length. The relatively unchanging transmission spectrum between 300 and 800 nm for the 1-h film is a useful feature for background correction. These optical data do not represent a limiting case. Rather, the optical throughput can be adjustable through controlled variations in the deposition conditions-a research task that is presently underway.

A background cyclic voltammetric i-E curve (in 1 M KCl) for the 1-h film is shown in FIG. 10. This measurement and the voltammetric measurements discussed below, for which the data are summarized in Table 1, were made in a standard, single compartment electrochemical cell.

TABLE 1
Table 1. Summary of Cyclic Voltammetric Data for a
1-h Diamond Thin Film Deposited on Quartz

| redox | ΔEₚ | Eₚ_{^{/2}} (mV vs | iₚ^{ox} | | |
|---|---|---|---|---|---|
| system | (mV) | Ag/AgCl) | (μA) | iₚ^{ox}/iₚ^{red} | Qₚ^{ox}/Qₚ^{red} |
| Ru(NH₃)₆^{3+/2+} | 59 | −165 | 5.0 | 0.99 | 1.1 |
| Fe(CN)₆^{3-/4-} | 67 | 276 | 6.3 | 1.1 | 1.0 |
| chlorpromazine | 84 | 652 | 5.6 | 1.5 | 1.5 |

The response is featureless over the entire potential range, as expected, but the current magnitude is slightly larger than that normally observed for boron-doped diamond films deposited on Si substrates. The anodic current density at 0.1 V is 7 μA/cm², compared to ˜2 μA/cm for a diamond film on Si (Granger, M. C., et al., Anal. Chem. 72 3793-3804 (2000); and Granger, M. C., et al., J. Electrochem. Soc. 146 4551-4558 (1999)). The anodic current at 1.25 V is due to the onset of chlorine evolution, and the cathodic current at −1.6 V is attributed to hydrogen evolution. The shape of this curve, which was unchanging with repeated cycling, is typical for films void of appreciable quantities of electroactive, sp²-bonded carbon impurities on the surface.

Cyclic voltammetry was used to investigate the response of the 1-h film electrode for the following redox systems: 0.1 mM Ru(NH₃)₆+1 M KCL, 0.1 mM Fe(CN)₆^{3-/4-}+1 M KCL, and 0.1 mM CPZ+10 mM HClO₄. A summary of the cyclic voltammetric data is presented in Table 1. The cyclic voitammetric ΔEₚ for Ru(NH₃)₆^{3+/2+} is relatively insensitive to the surface microstructure and chemistry of diamond, and other electrodes such as glassy carbon, but is sensitive to the electronic properties (i.e., density of states) at the standard reduction potential for the couple(Granger, M. C., et al., Anal. Chem. 72 3793-3804 (2000); Chen, P., et al., Anal. Chem. 67, 3115-3122 (1995); and Chen, P., et al., Anal. Chem. 68 3958-3965 (1996)). Therefore, this redox system is useful for probing the diamond film's electronic properties. ΔEₚ is 59 mV at this scan rate (100 mV/s), indicating the electrode has a high density of electronic states at these potentials, sufficient to support rapid electrode-reaction kinetics. As expected for currents limited by semi-infinite linear diffusion, iₚ^{ox} varies linearly (r²>0.99) with the scan rate^{1/2} The iₚ^{ox}/ₚ^{red} and Qₚ^{ox}/Qₚ^{red} ratios are near 1.0 for scan rates between 10 and 500 mV/s.

ΔEₚ for Fe(CN)₆^{3-/4-} is relatively insensitive to the surface microstructure of diamond but is very sensitive to the electronic properties and surface chemistry (Granger, M. C., et al., Anal. Chem. 72 3793-3804 (2000); Granger, M. C., et al., J. Electrochem. Soc. 146 4551-4558 (1999)). ΔEₚ is very sensitive to the surface microstructure and chemistry of glassy carbon (Chen, P., et al., Anal. Chem. 67 3115-3122 (1995); and Chen, P., et al., Anal. Chem. 68 3958-3965 (1996)). Specifically, ΔE is much larger at diamond electrode surfaces terminated with oxygen functional groups than at surfaces terminated with hydrogen (Granger, M. C., et al., J. Electrochem. Soc. 146 4551-4558 (1999)). The oxygen functional groups apparently block reaction sites that are available on the hydrogen-terminated surface; hence, the reaction kinetics are inhibited. Therefore, this redox system is useful for probing both the electronic properties and the extent of hydrogen termination. ΔEₚ for this redox couple is 67 mV at this scan rate (100 mV/s), indicating the electrode has a high density of electronic states at these potentials and the surface is predominately hydrogen-terminated, even after the numerous electrochemical measurements that were performed. The iₚ^{ox} for this analyte varies linearly (r²>0.99) with the scan rate^{1/2}, indicating that the current is limited by semi-infinite linear diffusion of the reactant to the interfacial reaction zone. The iₚ^{ox}/iₚ^{red} and Qₚ^{ox}/Qₚ^{red} ratios are stable, near 1.0, for scan rates between 10 and 500 mV/s.

The cyclic voltammetric ΔEₚ for CPZ is relatively insensitive to the surface chemistry and microstructure of diamond but is sensitive to the electronic properties (Granger, M. C., et al., Anal. Chem. 72 3793-3804 (2000); and Granger, M. C., et al., Anal. Chim. Acta 397 145-161 (1999)). CPZ has also been shown to undergo rapid electron transfer at polished, glassy carbon (sp²-bonded carbon), behaving as an outer-sphere system with respect to electron transfer (Yang, H.-H., et al., Anal. Chem. 71 4081-4087 (1999)). CPZ shows a tendency to adsorb on glassy carbon, but inhibiting adsorption by surface modification has little effect on the electrode kinetics (Yang, H.-H., et al., Anal. Chem. 71 4081-4087 (1999)). No significant adsorption, however, has been found for hydrogen-terminated, boron-doped diamond (sp³-bonded carbon) Granger, M. C., et al., Anal. Chem. 72 3793-3804 (2000); Granger, M. C., et al., Anal. Chim. Acta 397 145-161 (1999); and Xu, J., Doctoral Thesis, Utah State University, Logan, Utah (1999)). ΔEₚ for CPZ is relatively insensitive to surface chemistry at both surfaces (Granger, M. C., et al., Anal. Chem. 72 3793-3804 (2000); Granger, M. C., et al., Anal. Chim. Acta 397 145-161 (1999); and Yang, H.-H., et al., Anal. Chem. 71 4081-4087 (1999)). However, iₚ^{ox} varies linearly with scan rate at glassy carbon, as expected for an adsorbed species, and it varies linearly with (scan rate)^{1/2} at diamond, as expected for a species diffusing to the interfacial reaction zone (Granger, M. C., et al., Anal. Chim. Acta 397 145-161 (1999)). CPZ undergoes two 1-electron oxidation reactions in acidic media (Cheng, H. Y., et al., J. Am. Chem. Soc. 100 962-967 (1978)).

CPZ→CPZ^{·+}+e⁻

CPZ^{+·}→CPZ²⁺+e⁻

CPZ²⁺+H₂O→CPZO+2H⁺

The first electron-transfer reaction to form CPZ^{·+} is reversible, but the second reaction to form CPZ²⁺ is chemically irreversible, because the dication product undergoes rapid reaction with water to form an electroinactive sulfone (Cheng, H. Y., et al., J. Am. Chem. Soc. 100 962-967 (1978); and Ates, S., et al., J. Chem. Soc. Faraday Trans. 1 77 859-867 (1981)).

TABLE 2
Table 2. Optical and Electrical Stability Tests of
ITO/Quartz OTEs during 48-h Solution Exposures

| | Δ% T at | ρ before soak | ρ after soak |
|---|---|---|---|
| solvent | 275 nm | (Ω · cm) | (Ω · cm) |
| toluene | −0.111 | 3.8 × 10⁻⁵ | 3.8 × 10⁻⁵ |
| hexane | −0.113 | 3.8 × 10⁻⁵ | 3.8 × 10⁻⁵ |
| methanol | −0.195 | 3.8 × 10⁻⁵ | 3.7 × 10⁻⁵ |
| 1 M NaOH | +30.7 | 3.8 × 10⁻⁵ | >10³ |
| 1 M HNO₃ | +40.2 | 3.7 × 10⁻⁵ | >10³ |
| CH₂Cl₂ | +45.4 | 3.8 × 10⁻⁵ | >10³ |

The voltammetric results reported herein are for the first 1-electron redox reaction. The cyclic voltammetric i-E curve for 0.1 mM CPZ+10 mM HClO₄ was very similar in shape to curves for diamond and glassy carbon published previously and had the characteristic shape of a redox reaction controlled by semi-infinite linear diffusion (Granger, M. C., et al., Anal. Chem. 72 3793-3804 (2000); Granger, M. C., et al., Anal. Chim. Acta 397 145-161 (1999); Yang, H.-H., et al., Anal. Chem. 71 4081-4087 (1999); and Xu, J. Doctoral Thesis, Utah State University, Logan, Utah (1999); and Cheng, H. Y., et al., J. Am. Chem. Soc. 100 962-967 (1978)). The ΔEₚ is 84 mV at 100 mV/s. The iₚ^{ox} value varies linearly with the scan rate^{1/2} between 20 and 500 mV/s. These results indicate that the surface exposed to solution was predominately composed of sp³-bonded diamond with an insignificant amount of sp²-bonded amorphous carbon. The iₚ^{ox}/iₚ^{red} and Qₚ^{ox}/Qₚ^{red} ratios are greater than 1, and this is attributed to the fact that some production of CPZ²⁺ occurs during the forward sweep that undergoes hydrolysis and is, thus, unavailable for reduction during the reverse sweep.

Normally, with diamond films deposited on electrically conducting substrates, the current is passed through the diamond film and the conductive substrate to a metal current collector in contact with the backside of the substrate. In this case, however, such a current path was not possible, due to the electrically insulating quartz. Therefore, the current was passed laterally through the electrode to a metal current collector positioned at the edge of the film. The low ΔEₚ values indicate that the grains are in good electronic communication with the grain boundaries, providing a low-resistance current pathway. Again, the resistivity of the diamond film is 0.026 Ω·cm. Preliminary Hall effect measurements revealed a carrier concentration of ˜4×10²⁰ cm⁻³ and a resistivity of 0.059 Ω·cm.

The morphological, optical, and electrochemical stability of diamond and commercial ITO film OTEs were compared. In the first series of comparison measurements, ITO films, coated on quartz, were soaked for 48 h in different organic solvents, and strong acid and alkaline solutions with the optical properties and film resistivity recorded before and after. The results are summarized in Table 2. While no significant changes in either the optical or electrochemical properties were observed after exposure to methanol, hexane, or toluene, films soaked in 1 M HNO₃, 1 M NaOH, and dichloromethane showed significant increases in the optical transparency (presented as A % T at 275 nm) and electrical resistivity. The resistivity increased to at least 103 Ω·cm, as this is the maximum value measurable in our system. Both changes result from partial to complete removal of the ITO from the quartz surface. HNO₃ (1 M), NaOH (1 M), and dichloromethane are apparently effective in dissolving the film from the substrate. In contrast, the optical transparency (40-50%) and resistivity (0.026 Ω·cm) of the diamond thin film were unchanged after soaking in any of the solutions. In a second series of measurements, ITO films, coated on quartz, were anodically and cathodically polarized, using cyclic voltammetry, in 1 M HNO₃ and NaOH. Significant increases in the optical transparency and electrical resistivity were found after anodic and cathodic polarization in both electrolytes, more so in the acid. For example, the polarization, performed in HNO₃ (five scans) between 2.2 and −0.55 V with a maximum current density of 0.15 mA/cm², caused the optical transparency at 275 nm to increase by 45% and the resistivity to increase to 103 Ω·cm, or greater. Such a large increase in the transparency suggests that most of the ITO film was removed from the surface. In contrast, the morphological, optical, and electrical properties of the diamond film were unchanged after the polarizations in either HNO₃ or NaOH. For instance, the optical transparency (40-50%) and resistivity (0.026 Ω·cm) were unchanged after polarization in HNO₃ (10 scans) between 0.75 and −1.7 V with a maximum current density of 0.20 mA/cm².

The reproducibility of the diamond OTE's optical and electrochemical properties was superb from film to film—better, in fact, than the ITO samples tested. On the other hand, ITO is notoriously variable, in terms of its chemical nature, the distribution of crystalline and amorphous regions, the tin and indium oxide and hydroxide content (Donley, C., et al., Langmuir 18 450-457 (2002), and the electronic properties (Liau, Y.-H., et al., J. Phys. Chem. B 105 3282-3288 (2001)). The surface chemistry, modified by either intentional modification or adventitious adsorption of contaminants, can impact the properties of ITO, particularly the work function (Chaney, J. A., et al 180 214-226 (2001)). Thus, the heterogeneous nature of ITO often leads to significant variability in the optical and electrical properties from type to type (Donley, C., et al., Langmuir 18 450-457 (2002); Liau, Y.-H., et al., J. Phys. Chem. B 105 3282-3288 (2001); and Chaney, J. A.; et al., Appl. Surf. Sci. 180 214-226 (2001)). The stability of the 1-h diamond OTE was further tested by measuring UV-visible transmission spectra, in the thin-layer spectroelectrochemical cell, during potentiodynamic cycling in 1 M KCl. FIG. 11A shows spectra before polarization and after 15 and 30 cycles between −0.6 and +1.2 V versus Ag-QRE at a scan rate of 25 mV/s. The anodic potential limit extends into the chlorine evolution region with a maximum current of 0.075 mA/cm². Chlorine evolution, in general, is microstructurally damaging to sp²-bonded carbon electrodes (Chen, Q. Y., et al., J. electrochem. Soc. 144 3806 (1997)). Although this is a low-current density, there are no significant changes observed in the optical spectra and there also were no changes observed in the voltammetric response.

FIG. 11B shows a series of transmission spectra, measured after removal from the thin-layer cell, for the same film before polarization, after 10 cycles over a 2.45-V potential range in 1 M HNO₃, and after 5 cycles over a 2.25-V potential range in 1 M NaOH. The potential cycling in both media extended well into the hydrogen and oxygen evolution regions. Again, there is no significant variation in the transmission spectra after cycling in either solution.

FIG. 12 presents a background-corrected cyclic voltammetric i-E curve for 0.1 mM CPZ+10 mM HClO₄, measured in the thin-layer spectroelectrochemical cell. The scan rate was 2 mV/s. The Qₚ^{ox}/Qₚ^{red} ratio is ˜1, and the peaks are approximately Gaussian in shape with no evidence of diffusion. iₚ^{ox} and iₚ^{red} varied linearly with the scan rate, while Qₚ^{ox} and Qₚ^{red} were independent of the scan rate. These observations are predicted for thin-layer voltammetric behavior (Hubbard, A. t., et al., Anal. Chem. 38 58-61 (1966); Bard, A. J., et al., Electrochemical Methods: Fundamentals and Applications, John Wiley & Sons: New York (1980); and Kuwana, T., et al., In Electroanalytical Chemistry, Bard, A. J., Ed.; Marcel Dekker: New York Vol. 7, pp 1-78 (1974)). ΔEₚ is 68 mV, larger than the 0 mV expected if the electrode kinetics are fast, relative to the scan rate. It is believed the larger-than-expected ΔEₚ is due, at least in part, to uncompensated resistance in the cell. The Q_{P}^{ox} value, 56 μC, is consistent with the charge calculated for 4.8 μL of 0.1 mM CPZ (n) 1), 46 μC. The peak current for a cyclic voltammetric i-E curve under thin-layer conditions is predicted to be (Hubbard, A. t., et al., Anal. Chem. 38 58-61 (1966); Bard, A. J., et al., Electrochemical Methods: Fundamentals and Applications, John Wiley & Sons: New York (1980); and Kuwana, T., et al., In Electroanalytical Chemistry, Bard, A. J., Ed.; Marcel Dekker: New York Vol. 7, pp 1-78 (1974))

iₚ=(9.39×10⁵)n²νVCₒ*

where n is the number of electrons transferred per equivalent, ν is the scan rate (ν/s), V is the cell volume (cm³), and Cₒ* is the bulk concentration (mol/cm³). The iₚ^{ox} value in FIG. 6 of 0.86 μA, is in good agreement with the predicted value of 0.90 μA.

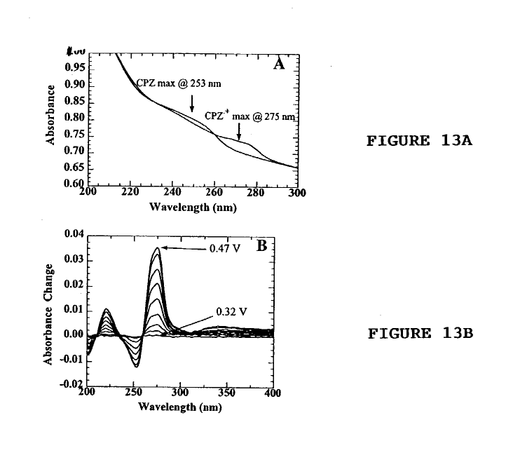

UV-visible spectroelectrochemical measurements for the first 1-electron-transfer reaction of chlorpromazine, CPZ^{o/·+}, were performed, and the absolute spectra recorded during anodic (0.50 V) and cathodic (0.30 V) potential steps are presented in FIG. 13A. The spectral changes for CPZ are recorded on a sloping background, as the diamond OTE exhibits a changing transmittance at these wavelengths (see FIG. 9). CPZ has an absorbance maximum at 253 nm, due to a π→π* transition (εₒ˜10 000 L/mol·cm), while the radical cation produced by a 1-electron oxidation has an absorbance maximum at 275 nm (Ates, S., et al., J. Chem. Soc., Faraday Trans. 1 77 859-867 (1981)). This is presumably also due to a π→π* transition (εₒ˜20 000 L/mol.cm). In FIG. 13B, a series of difference spectra (oxidized form—reduced form) are presented for different applied potentials. As the potential is stepped positively from 0.32 to 0.47 V, the peak at 253 nm gradually decreases and the peak at 275 nm increases. A peak at 224 nm also develops as the applied potential is made more positive. The spectral features can be reversibly formed with changes in the applied potential. A background spectrum for the cell containing fully reduced CPZ was subtracted from each of the spectra to present the absorbance changes relative to a flat baseline. When overlaid, the spectra show well-defined isosbestic points. The isosbestic point near 260 nm indicates that the species responsible for the absorbance peaks on either side of the point are stoichiometrically related. Here, these peaks are due to CPZ and CPZ^{·+}.

A calibration curve was constructed, based on the absorbance change at 275 nm as a function of solution concentration. The plot was linear between 20 μM and 1 mM with a linear regression correlation coefficient of 0.9996 and a near-zero (0.0095 AU) ordinate intercept. The absorbance change was measured during a potential step from 0.30 to 0.50 V. This linear response curve indicates that the diamond OTE provides an analytically useful signal for the detection of CPZ. A 0.5 μM limit of detection (S/N=3) is estimated from the data. A Nernst plot of applied potential versus ln[0]/[R], calculated from absorbance changes at 253 nm, was also constructed. The plot was linear, as predicted, with a linear regression correlation coefficient of 0.9990, and has an intercept of 0.41 V, close to the E_{p/2} of 0.43 V, determined from the thin-layer cyclic voltammetric i-E curve presented in FIG. 12. The slope of this plot was 56.9 mV, and is close to the 59.2/n mV (n) 1) predicted by the Nernst equation. The slope also indicates that the oxidation of CPZ to CPZ^{·+} involves the loss of 1 electron.

### SUMMARY

The electrochemical and optical properties of a boron-doped diamond OTE were evaluated. The diamond OTE is a thin (<1000 nm) film deposited on quartz and exhibits superior morphological, optical, and electrical stability during exposure to strongly acidic and alkaline solution and chlorinated organic solvents. The diamond OTE also exhibits superior stability during anodic and cathodic polarization in strongly acidic or alkaline media. Good electrochemical responsiveness is observed for Ru(NH₃)₆^{3+/2+}, Fe(CN)₆^{3-/4-}, and CPZ^{0/·+} without any electrode pretreatment. The diamond OTE has a high carrier concentration, 10²⁰ cm⁻³ (holes), and low electrical resistivity (˜0.026 Ω·cm) laterally through the grains and grain boundaries. The material has a high density of electronic states between −0.35 and 0.8 V versus Ag/AgCl, sufficient for rapid electrode reaction kinetics. The spectroelectrochemical performance of the diamond OTE was evaluated in a specially designed, thin-layer cell, using chlorpromazine. Well-defined, thin-layer voltammetry is observed with Qₒ^{ox} values independent of scan rate, as expected for thin-layer behavior. For CPZ measurements, the linear dynamic range is from 20 to 100 μM and the estimated limit of detection is 0.5 μM (S/N=3). A linear Nernst plot is observed with a slope of 56.9 mV, reflective of 1 electron being transferred per equivalent during the oxidation of CPZ to CPZ^{·+} and an ordinate intercept of 0.41 V.

The diamond films coated on quartz represent the most practical form of the diamond OTE, but this form is only useful for spectroelectrochemical measurements in the UV/visible region of the electromagnetic spectrum. Thin films of diamond coated on undoped Si are useful for OTEs for spectroelectrochemical measurements in the IR region of the electromagnetic spectrum. The present invention includes free standing diamond, thin films on quartz (UV/Vis) and thin films on undoped Si.

It is intended that the foregoing description be only illustrative of the present invention and that the present invention be limited only by the hereinafter appended claims.

We claim:

1- A method for spectroscopically observing an oxidation-reduction reactions which comprises:
(a) providing an oxidation and reduction reaction cell comprising a smooth light transparent electrode of conductive polycrystalline diamond doped with an electrically conductive element;
(b) introducing a reagent for the oxidation or reduction reaction into the cell; and
(c) conducting the oxidation or reduction with the reagent activated by electrical conduction through the electrode while spectroscopically measuring a change of the reagent or derivative thereof in the cell through the electrode over time.

2- The method of claim 1 wherein the diamond is doped with boron.

3- The method of claim 1 or 2 wherein the electrode is less than about 350 micrometers thick.

4- The method of claim 1 wherein the electrode as a surface which is in contact with the reagents which is hydrogen terminated initially.

5- The method of any one of claims 1, 2 or 4 wherein the diamond is deposited on a transparent quartz substrate.

6- In a cell for spectroscopically observing an oxidation and reduction reaction wherein the reaction is conducted in a cell with a reagent for the oxidation reduction reaction adjacent to a spectroscopic electrode, the improvement which comprises a smooth, conductive polycrystalline diamond electrode doped with an electrically conductive element, wherein the electrode allows for spectroscopic measurement of a change of the reagent or derivative thereof in the cell through the electrode over time when activated by electrical conduction through the electrode.

7- The cell of claim 6 coupled with a spectrophotometer.

8- The cell of claim 6 wherein the diamond is doped with boron.

9- The use of claims 6 or 7 wherein the electrode is less than about 350 micrometers thick.

10- The cell of claim 6 wherein the electrode has a surface in contact with the reagents which is hydrogen terminated initially.

11- The cell of any one of claims 7, 8 or 10 wherein the diamond is deposited on a transparent quartz substrate.
